(19) United States
(12) Patent Application Publication
(10) Pub. No.: US 2007/0044325 A1
(43) Pub. Date: Mar. 1, 2007

(54) Direct drive industrial can opener

(75) Inventor: Wun C. Chong, Delta (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: CanPacific Engineering Inc., Delta (CA)

(21) Appl. No.: 11/214,847

(22) Filed: Aug. 31, 2005

(51) Int. Cl. B67B 7/46

(52) U.S. Cl. 30/400

(57) ABSTRACT

This invention relates to a novel direct drive can opener. More particularly, the invention is directed to a novel direct drive can opener which can be operated by hand or by motor, accommodates various sizes of cans and cuts the outer seam wall of a can, rather than the top lid of the can. A can opener comprising: (a) a rotatable cutting wheel having a serially notched cutting edge for severing a first side of a can seam of a can; (b) a rotatable traction wheel having a gripping surface for engaging a second side of the can seam opposite the cutting wheel; (c) a rotary handle associated with said traction wheel for rotating said traction wheel; and (d) a second member for engaging or disengaging said cutting wheel and said traction wheel, on said can seam, the cutting wheel axis and the traction wheel axis being substantially parallel when the first member is engaged with the second member.

### FIELD OF THE INVENTION

This invention relates to a novel gearless direct industrial drive can opener. More particularly, the invention is directed to a novel gearless direct drive industrial can opener which can be operated by hand or by motor, accommodates various sizes of cans and cuts the outer seam wall of a can, rather than the top lid of the can.

### BACKGROUND OF THE INVENTION

Can openers used for opening cans of preserved produce are well known. In general, they cut the lid of the can by utilizing a combination of a traction wheel and a cutting wheel. The traction wheel is usually driven and acts as a reaction surface against the can wall or can seam. It acts to drive the can opener around the top lip (seam) of the can while the sharpened cutting wheel rotates and cuts through the can lid.

The most common type of can opener available is one that cuts the top lid of the can at a location inside the top circumferential seam of the can. The disk-like cut lid is then removed to gain access to the can contents through the top of the can. A problem with this mode of opening a can is that the non-sterilized cutting blade cuts down through the circumference of the circular lid and tends to contact the sterilized preserved contents of the can. If the cutting blade is contaminated from previous use and bacteria and debris have accumulated on the cutting blade, the contents of the can are contaminated. Another problem with this type of can opener is that if the cutting blade is not particularly sharp, it will not cut the lid cleanly. Consequently, small metal shavings and metal slivers are created and they fall into and contaminate the contents of the can. A further problem is that if the entire circumference of the circular top can lid is cut, the lid with its contaminated exterior side often falls into the can and contaminates the can contents. To aggravate the situation, it can often be a difficult and messy exercise to remove the cut lid from the interior of the can.

To address these problems, can openers have been developed that are designed to cut the outside seam of the can, rather than the lid. Examples of these can openers include U.S. Pat. No. 3,719,991 to French; U.S. Reissued Pat. No. 27,504 to Smith; U.S. Pat. No. 1,935,680 to Von Wolforsdorf; U.S. Pat. No. 4,782,594 to Porucznik et al. and U.S. Pat. No. 3,510,941 to Fyfe. All these patents disclose a can including a pin sliding in an arcuate slot for engaging and locking the can opener on the can to be opened. While these arrangements work adequately, over time there is a tendency for the moving parts to wear. The result is that the engaging and locking function of the opener is impaired thereby leading to difficulty in cutting the can and keeping the opener in position on the can.

U.S. Pat. No. 5,121,546, granted Jun. 16, 1992, to the subject inventor, Wun C. Chong, discloses an effective solution of the above discussed wear problem. In the can opener disclosed in U.S. Pat. No. 5,121,546, there are thrust surfaces and a separating mechanism that can be introduced between the thrust surfaces. The separating mechanism, typically a ball bearing, is introduced between the thrust surfaces and moves a movable thrust surface away from a fixed thrust surface to separate a movable wheel, usually the traction wheel, and a cutting wheel. Using this mechanism, the can opener is brought to the cutting position. The traction wheel can then be rotated to cut the seam of the can.

U.S. Pat. No. 5,367,776, granted Nov. 29, 1994, to the subject inventor, Wun C. Chong, discloses a can opener comprising a housing having a manually operable handle. The cutting wheel has a cutting edge for severing the seam of the can wall, with the cutting wheel defining a cutting wheel axis. The can opener also has a traction wheel which has a gripping surface. This gripping surface engages the can with the traction wheel defining a traction wheel axis. The can opener also includes a mechanism for rotatably mounting the traction wheel and the cutting wheel in the housing such that their respective axes of rotation are substantially perpendicular and the wheels are positioned adjacent and spaced apart from each other to define a gap to accept the seam of the can to be opened. One of the wheels is movable towards the other wheel in order to engage and lock the can between the cutting wheel and the traction wheel so that the cutting wheel acts to sever the seam of the can wall. The traction wheel acts to move the can past the cutting wheel.

U.S. Pat. No. 6,158,130, granted Dec. 12, 2000, to the subject inventor, discloses a heavy duty industrial can opener operated by hand or by motor which accommodates various sizes of cans and cuts the outer seam wall of the can rather than the top lid of the can. The can opener includes a cutting wheel with a cutting edge and a traction wheel with a gripping surface. The cutting and traction wheels each have associated gears for rotating the wheels. The gear for the traction heel is releasably engageable with the gear of the cutting wheel. One of the gears is driven to rotate both the cutting and traction wheels. A cam lock provides a series of levers and link pins which provide the ability to releasably engaged and disengaged the gears. The distance between the cutting wheel and the traction wheel is automatically adjusted while the cam is locked in place

### SUMMARY OF THE INVENTION

The invention is directed to a can opener comprising: (a) a rotatable cutting wheel which has thereon a serially notched cutting edge for severing a first side of a can seam of a can, said cutting wheel defining a cutting wheel axis; (b) a rotatable traction wheel which has thereon a gripping surface for engaging a second side of the can seam opposite the cutting wheel, said traction wheel defining a traction wheel axis; (c) a first member associated with said traction wheel for rotating said traction wheel; and (d) a second member for engaging or disengaging said cutting wheel and said traction wheel on opposite sides of the can seam, the cutting wheel axis and the traction wheel axis being substantially parallel when the cutting wheel and the traction wheel are engaged on the can seam.

The can opener can include a resilient bumper mechanism for enabling the distance between the cutting wheel and the traction wheel to be varied. The can opener can include an adjustable mechanism impinging on the resilient bumper mechanism for enabling the distance between the cutting wheel and the traction wheel to be varied to adjust to differences in widths of can seam.

The cutting wheel can include thereon a serrated surface for gripping the seam of the can or a shoulder for aligning the can seam with the cutting wheel.

The traction wheel can include thereon a series of alternating ridges and grooves for gripping the seam of the can. The ridges and grooves of the traction wheel can be angled.

The cutting wheel can be contained in a first cutting wheel housing which can be removed from the interior of a second housing associated with the first member and the second member. The can opener can include a removable locking pin for securing the first cutting wheel housing in the second housing.

The can opener can include an abutment member for impinging on the top of the can and guiding the movement of the can in the can opener during a seam cutting operation. The abutment member can have a curved U-shape adapted to engage with a top of the can. The axis of the cutting wheel can be disposed at an angle with respect to the plane of the top of a can.

The first housing and the second housing can be mounted on a post and the elevation of the can opener on the post can be adjusted. The can opener can include a resilient bumper at the base of the second housing. The post can be slidably mounted in a clamp mechanism for mounting the can opener on a bench. The clamp mechanism can include a U-shaped can base holder.

The first cutting wheel housing can be designed so that it fits within the second housing in only one orientation. The serially notched cutting edge of the cutting wheel can be located above the serrated surface which can be located above the shoulder.

### BRIEF DESCRIPTION OF THE DRAWINGS

In drawings which illustrate specific embodiments of the invention, but which should not be construed as restricting the spirit or scope of the invention in any way:

FIG. 1 illustrates a side partial section view of a manually operable embodiment of the direct drive can opener, with the opener in an open can receiving position.

FIG. 2 illustrates a side partial section view of a manually operable embodiment of the direct drive can opener, with the opener in a closed position about a can, ready for cutting the seam of the can.

FIG. 3 illustrates an isometric exploded view of the top portion of the direct drive can opener.

FIG. 4 illustrates an isometric exploded view of the can rest, post and clamp.

FIG. 5 illustrates a detail side partial section view of the traction wheel and the cutting wheel in a closed position cutting the top seam of a can.

FIG. 6 illustrates an enlarged detail view of the part of the traction wheel, part of the cutting wheel and part of a cut can.

FIG. 7 illustrates an enlarged isometric view of the cutting wheel.

FIG. 8 illustrates an enlarged isometric view of the traction wheel.

FIG. 9 illustrates a partial section plan view of the traction wheel, cutting wheel, can holder and cutting head housing.

FIG. 10 illustrates an enlarged isometric partial section view of the bumper, securing pin and housing.

### DESCRIPTION OF PREFERRED EMBODIMENTS OF THE INVENTION

The direct drive can opener according to the subject invention utilizes can seam cutting components which in some ways are similar in construction to parts which are disclosed and illustrated in my prior U.S. Pat. No. 5,367,776, granted Nov. 29, 1994, and U.S. Pat. No. 6,158,130, granted Dec. 12, 2000. However, the subject direct drive can opener incorporates many innovative components which provide a number of major advantages. The direct drive can opener according to the invention can be either-manually operable or motor operable. The manually operable version is discussed in detail below. The direct drive can opener according to the invention includes a securing lever for opening or closing the opener on a can and a rotary handle which, when rotated by the hand, enables the opener to cut the seam of the can.

The direct drive can opener according to the invention, when in a closed position, has the traction wheel and cutting wheel in planar alignment and opposed to one another so that the traction wheel abuts the interior side of the top seam of the can and the cutting wheel abuts and cuts the exterior side of the top seam of the can. When in a closed position, the aligned axis traction wheel abutting the inside of the seam, and the aligned axis cutting wheel abutting the exterior side of the can seam oppose and balance one another and enable the cutting edge of the cutting wheel to penetrate directly into the exterior side of the can seam. When the operator rotates the rotary handle, the can rotates and the can opener proceeds smoothly around the circumference of the can seam, and cuts the seam. Since the cut lid includes part of the seam and has a diameter larger than the inside diameter of the can, the cut lid and part of the seam cannot drop into the interior of the can. Also, since the cutting wheel is disposed at an angle to the can seam, it severs the can seam, rather than cutting it, thereby eliminating the possibility that metal shavings will be generated. Even if metal shavings are created, they drop harmlessly to the exterior of the can.

The direct drive can opener according to the invention does not include gears, which can jam or wear out. The traction wheel is driven directly by the rotating handle. The cutting wheel has around its circumference a series of ridges and grooves which give it grip on the exterior of the can seam. The traction wheel has around its circumference an angled series of grooves which grip the interior side of the can seam and prevent the traction wheel from riding up on the seam. Thus the horizontal drive force exerted on the interior side of the can seam, by rotating the handle, is translated through the can seam to the cutting wheel on the opposite side of the can seam, which in turn rotates the cutting wheel. The opposed horizontal forces maintain the can in a steady position and eliminate any twisting torque or squirming forces on the can seam as the rotary handle is rotated.

The direct drive can opener according to the invention is disengaged from the can seam, once the entire seam has been cut, by lifting the open-close securing lever at the side of the can opener. The can opener includes a curved U-shaped can abutment member which assists in aligning the can opener on the can so that an accurate and clean cut of the can seam can be made. The U-shaped can abutment member also assists in holding the can and seam in engagement with the can opener, during the seam cutting process.

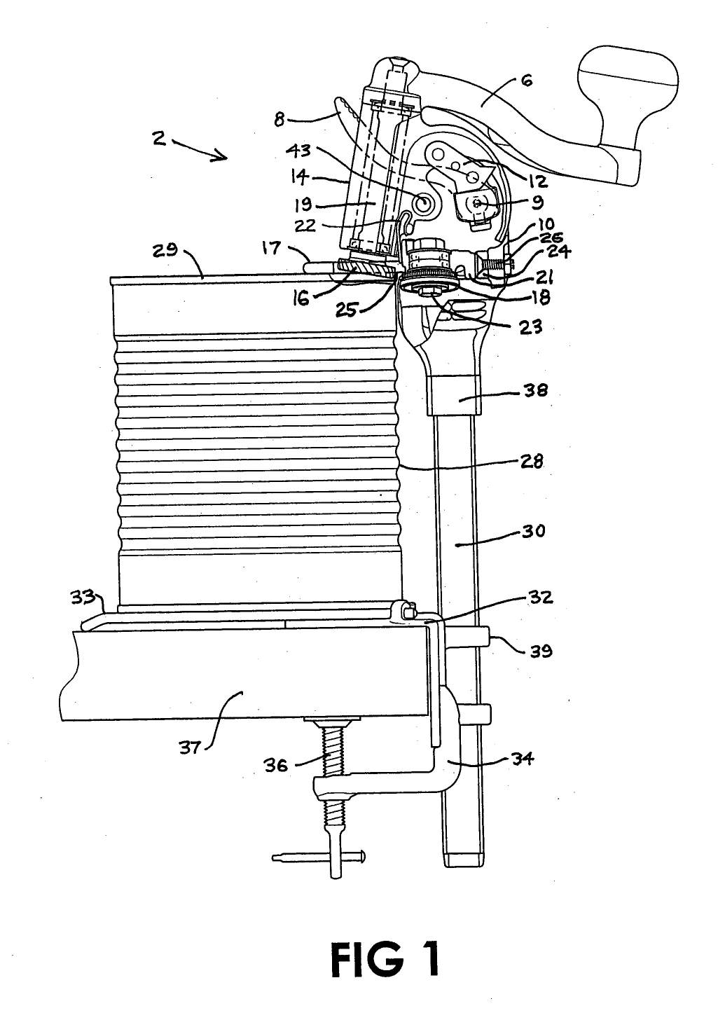

FIGS. 1 to 10 illustrate a manually operated embodiment of the direct drive can opener. FIG. 1 illustrates a side partial section side view of the industrial can opener 2 which comprises a housing 10 which has above it a rotary crank 6 and on its side a raise and lower securing lever 8 for opening and closing a traction wheel 16 and a cutting wheel 18 upon the respective inside and outside of the can seam 29.

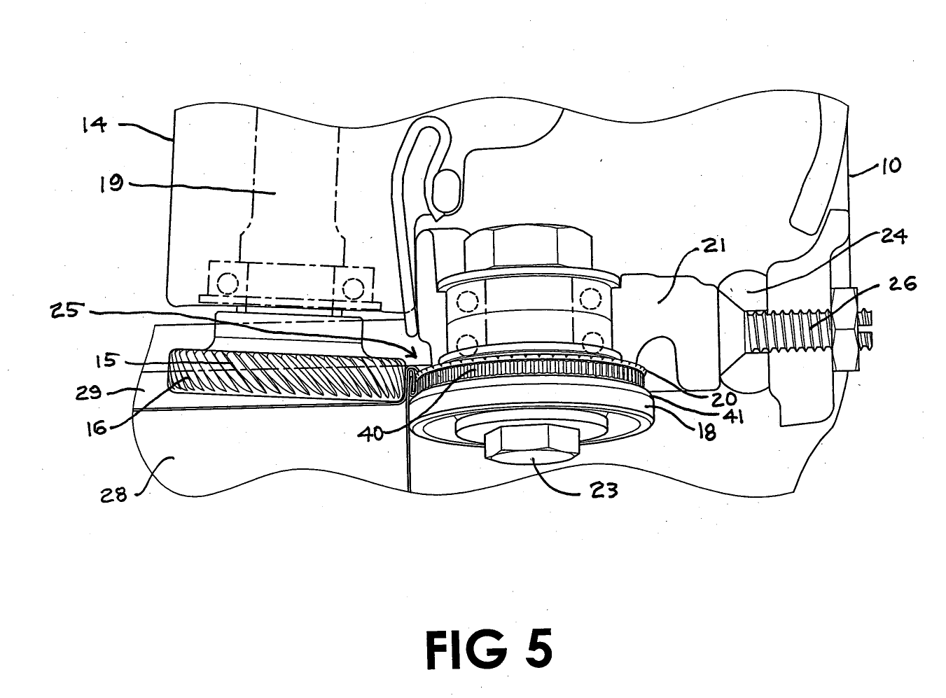

The cutting wheel 18 with a cutting edge 20 for severing the exterior side of the top seam 29 of the can 28, is shown in detail in FIGS. 5 to 7. The cutting wheel 18 is mounted inside a housing 21 on a rotatable shaft 23 that defines a cutting wheel axis.

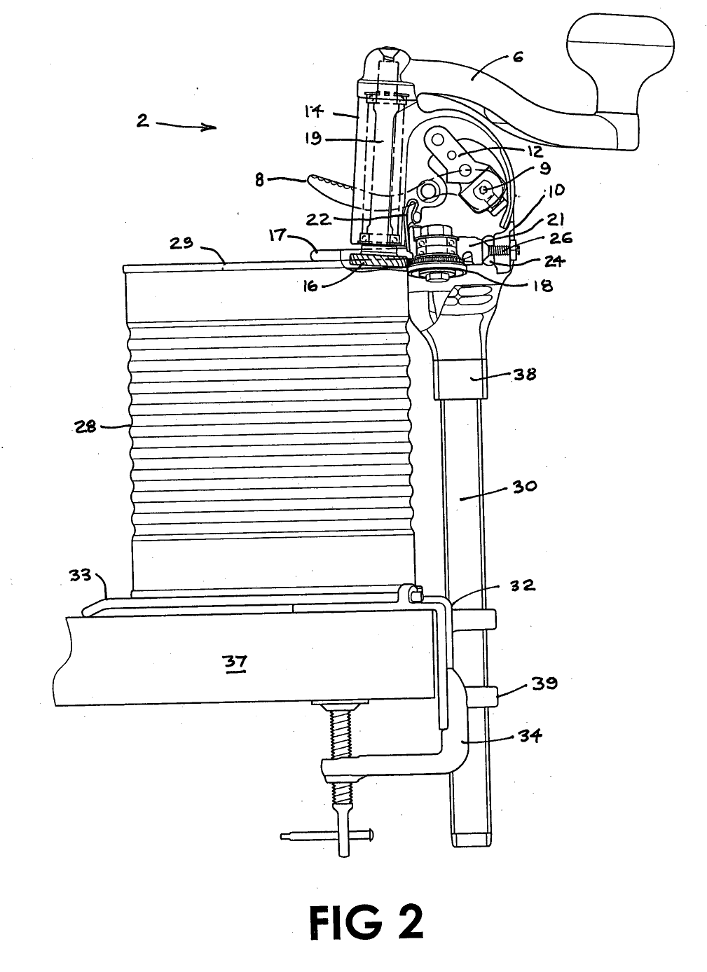

The traction wheel 16 has around its circumference an angled interior can seam gripping surface in the form of a series of ridges and grooves 15 as shown particularly in FIGS. 5, 6 and 8. The traction wheel 16 is mounted at the base of a direct drive shaft 19 that defines a traction wheel axis. The cutting wheel 18 mounted in housing 10 and the traction wheel 16 at the base of housing 14, in association with respective shafts 23 and 19, cooperate so that the axes of rotation of wheels 16 and 18 (when in a lowered position as shown in FIG. 2) are substantially perpendicular and parallel. It will be noted that with direct drive shaft 19, there are no intermediate gears which can wear out or become broken. Also, no lubricant is required. The cutting and traction wheels 16 and 18 are positioned adjacent to but spaced apart from each other to thereby define a gap 25 (see FIGS. 1 and 5) which is able to accept the width of the can seam 29 of the can 28 to be opened.

FIGS. 1 and 2 also illustrate the mechanism and operation of the linkages between the raise and lower securing lever 8 and the vertically moveable traction wheel 16. As seen in FIG. 1, the lever 8 and traction wheel 16 are in a raised position, and the pivot end 9 of lever 8 are connected by link arm 12 to the traction wheel shaft housing 14. The raise-lower housing 14 is mounted in rocking fashion on pivot end 9 and moves up and down in relation to housing 10. As also seen in FIG. 1, when the lever 8 is in a raised position, the traction gear 16 is raised and the gap 25 between traction wheel 16 and cutting wheel 18 is at a maximum distance. Spring 22 assists in moving the traction gear to a raised position.

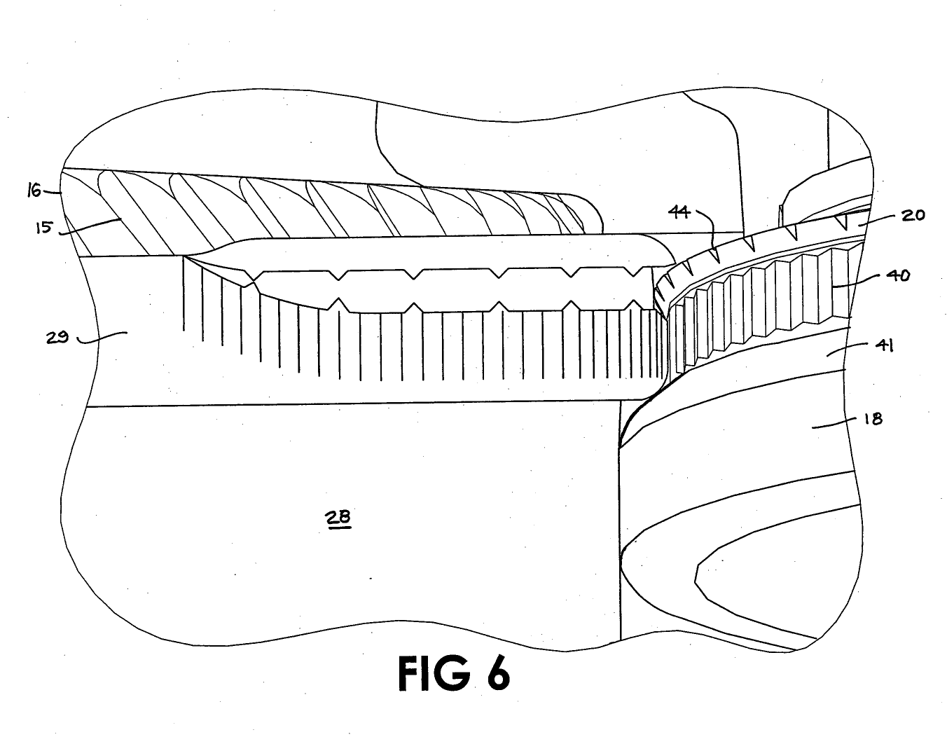

As seen in FIG. 2, which also illustrates a side partial section view of the can opener 2, the lever 8 and traction wheel 16 are in a lowered position. When the lever 8 is lowered, the traction wheel 16 moves towards the cutting wheel 18 to close the gap 25. This action friction engages the traction wheel 16 and the cutting wheel 18 so that they abut each side of the top seam 29 of the can 28, as shown in FIG. 2. When can 28 is so engaged, the traction wheel 16 and the cutting wheel 18 are rotated in counter-directions by turning the crank 6, which through shaft 19 drives traction wheel 16 and by friction through the can seam 29, the cutting wheel 18 on the exterior of the seam 29. The cutting edge 20 of the cutting wheel 18, as seen most clearly in FIG. 6, severs the exterior side of the can seam 29 as the traction wheel 16 bears against the internal side of the seam 29 and acts to move the can 28 and seam 29 past the rotating cutting edge 20 of the cutting wheel 18.

FIGS. 1 and 2 also illustrate the manner in which the manually operated can opener 2 can be mounted on a table or bench 37. The housing 10, together with the internal components including the link arm 12, the traction shaft housing 14, and the traction wheel 16 and cutting wheel 18, are mounted on a vertical post 30. The bottom end of the post 30 is slidably mounted in a pair of post grips 39 in an upper table clamp arm 32 which extends over the top of a table 37. A U-shaped can bottom mount 33 extends from the clamp arm 32 under the base of the can 28. A bottom clamp arm 34 with adjustable clamp 36 is connected to the underside of upper clamp arm 32 and enables the can opener assembly 2 to be mounted on the edge of a table or bench 37. The base of the housing 10 has a rubber bumper 38 which protects the housing 10 if it is slammed down on upper clamp arm 32, and top post grip 39.

As also seen, particularly in FIGS. 1 and 2, the gap 25 width is adjustable and can accommodate different widths of can seam 29 because the cutting wheel 18, shaft 23 and housing 21 abut a rubber bumper 24. The position of cutting wheel 18 can therefore move laterally because of the resiliency of rubber bumper 24. Traction wheel 16, on the other hand, is stationary in a horizontal direction, but can be moved upwardly or downwardly by raising or lowering lever 8 (see FIGS. 1 and 2). The position of the cutting wheel 18 and rubber bumper 24 relative to traction wheel 16 can be adjusted by using a screwdriver and rotating bolt 26 in the required direction.

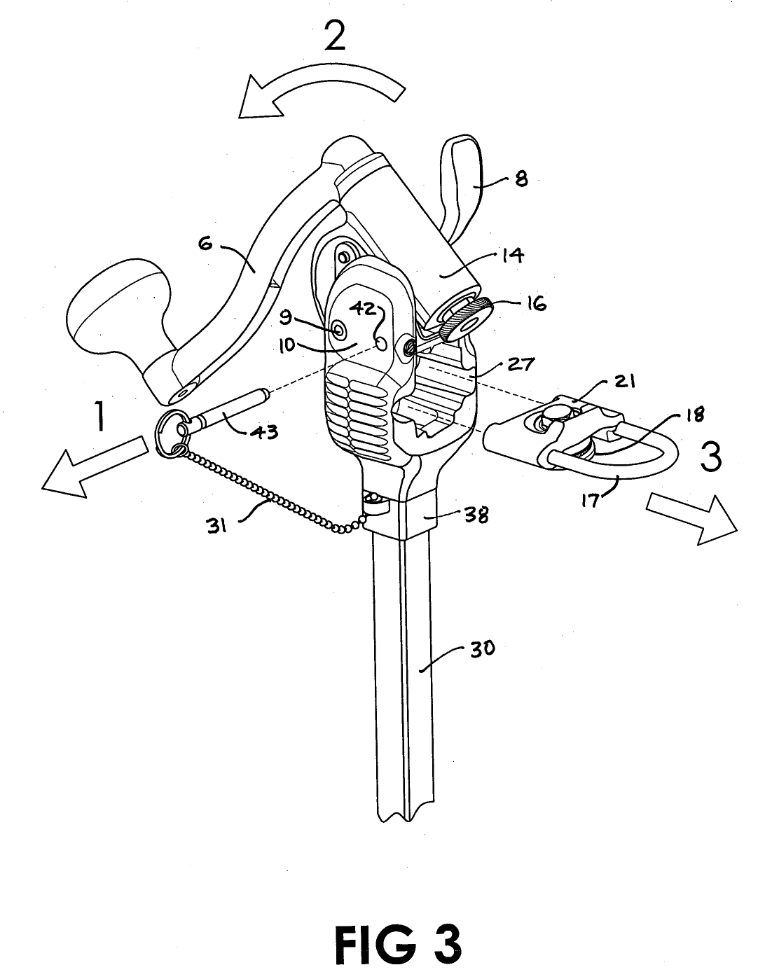

FIG. 3 illustrates an exploded isometric view of the top portion of the direct drive can opener. FIG. 3 illustrates in particular by means of the arrow how the rotating handle 6, the securing lever 8, the traction shaft housing 14 and traction wheel 16 can be tilted about pivot point 9 and housing 10 by removing locking pin 43, also indicated by an arrow. Locking pin 43 is connected to rubber bumper 38 by a chain 31. When handle 6, lever 8, housing 14 and traction wheel 16 are in a lowered position, the locking pin 29 can be inserted in hole 42 to hold all components in the lowered position. When locking pin 43 is removed, and housing 14 is raised, as indicated by the third arrow, U-shaped can holder 17, cutting wheel 18 and cutting wheel housing 21 can be extracted from the interior of housing 10 for ready cleaning and maintenance. One side of the cutting wheel housing 21 is larger than the other side, as is the opening 27 in the housing 10, so that the housing 21 and cutting wheel 18 cannot be improperly inserted in the housing 10 in an upside-down position.

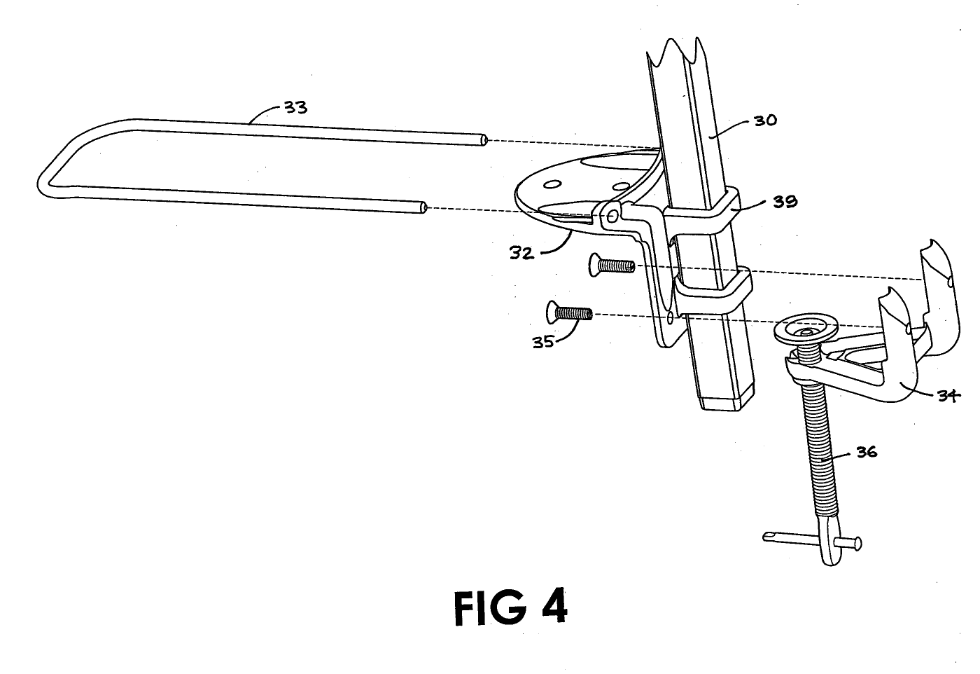

FIG. 4 illustrates an exploded isometric view of the can rest, post and clamp. As seen in FIG. 4, the U-shaped can bottom mount 33 is slidably mounted in holes in upper table clamp arm 32. The bottom clamp 34 is secured to the upper clamp arm 32 by a pair of bolts 35. The clamp assembly is tightened onto the underside of the bench by clamp 36. The vertical post 30 is slidably mounted in upper clamp arm 32 through a pair of grips 39 so the elevation of the post can be adjusted. When screw clamp 36 is tightened, the grips 29 by friction hold the post 30 at the desired elevation.

FIG. 5 illustrates a detail side partial section view of the traction wheel and the cutting wheel in a closed position cutting the top seam of a can. As shown particularly in section view in FIG. 5, the cutting wheel 18 is formed with cutting edge 20 and an underlying serrated sawtooth-like circumferential area 40 that ensures a good grip of the cutting wheel 18 on the exterior of the can seam 29. Underlying the serrated area 40 is a shoulder 41 that abuts the exterior underside of the top seam 29 so that the cutting wheel 18 properly aligns with the seam 29 and is held in position against can seam 29 as the cutting edge 20 penetrates and severs the can seam 29 into two parts (see FIG. 6). The traction wheel 16 has around its circumference a series of angled ridges and grooves 15 which enhance its grip on the interior of the can seam 29.

The cutting housing 21 and wheel spindle shaft 23 are preferably mounted at an angle to the vertical. This improves the engagement of the cutting edge 20 of the cutting wheel 18 with the can seam 29 and ensures that a good severing action is obtained (see FIG. 6). An appropriate angle has been found to be about 12.5° from the vertical.

Referring to FIG. 6, which illustrates an enlarged detail partial side section view of the can opener engaged in a top seam severing orientation on a can 28, the traction wheel 16 with grooves 15 engage the interior side of the can seam 29. The cutting edge 20 of cutting wheel 18 severs the exterior rim of the can seam 29.

FIG. 6 also illustrates in detail how the shoulder 41 of the cutting wheel 18 engages the underside of the exterior of can seam 29 to correctly position the cutting edge 20 against the exterior of the can seam 29. It should be noted that the cutting wheel 18 has on its cutting edge 20, around its circumference, a spaced series of notches 44, which enhance the seam 29 severing operation. The notches 44 provide a series of alternating high and low seam penetrating forces on the exterior of the can seam 29, and thereby assist in the seam severing procedure. It has been discovered that the notches 44 provide a better seam severing action than a straight edge on the cutting blade. FIG. 6 also illustrates how the serrated area 40 on cutting wheel 18 leaves in imprint on the exterior of the can seam 29, indicating that a good grip has been achieved.

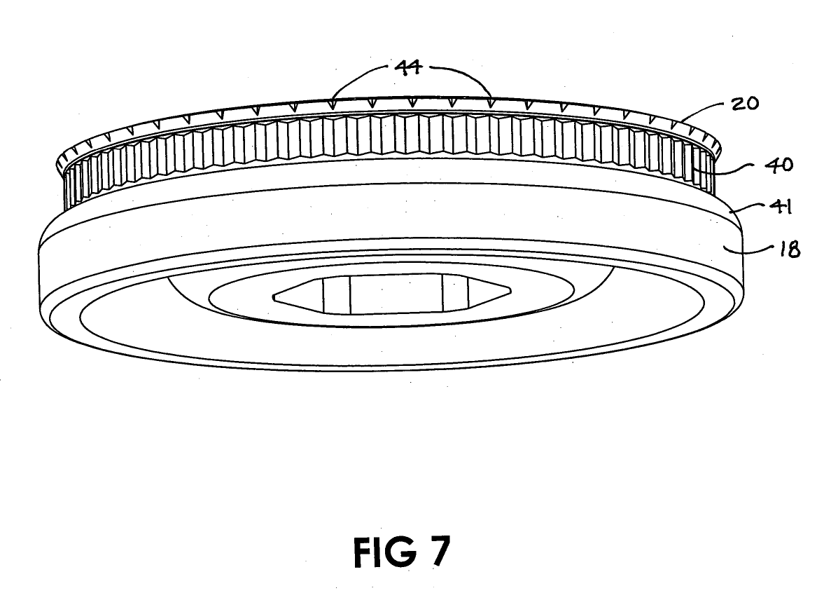

FIG. 7 illustrates an enlarged isometric view of the cutting wheel. FIG. 7 shows in detail the cutting wheel 18 with uppermost cutting edge 20, notches 44 around the circumference of the edge 20, serrated groove and ridge area 40 and shoulder 41. Shoulder 41 is positioned under the seam 29 and together with U-shaped can holder 17 (not shown) holds the can 28 securely so that the cutting edge 20 cuts the seam 29 consistently. If the shoulder 41 is absent, the can 28 will squirm and a consistent cut will not be made.

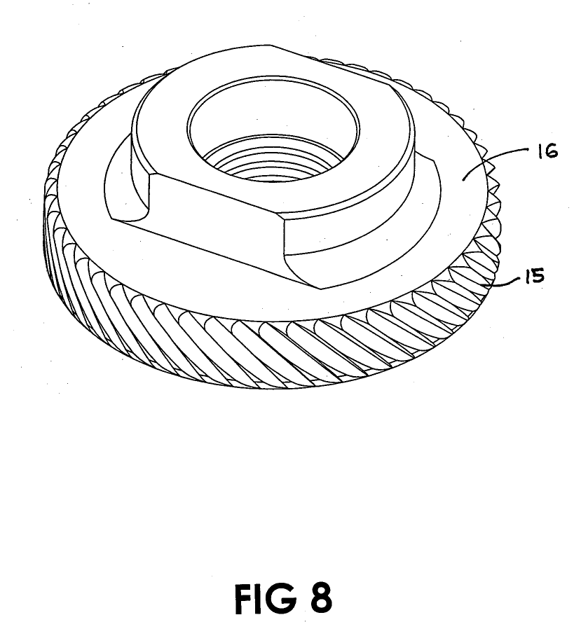

FIG. 8 illustrates an enlarged isometric view of the traction wheel. In particular, FIG. 8 shows the construction of the series of angled alternating ridges and grooves 15 on the circumference of the traction wheel 16. These are designed to firmly and consistently engage the inside edge of the can seam 29. The angle of the ridges and grooves 15 also hold the traction wheel 16 in place on the interior side of the can seam 29.

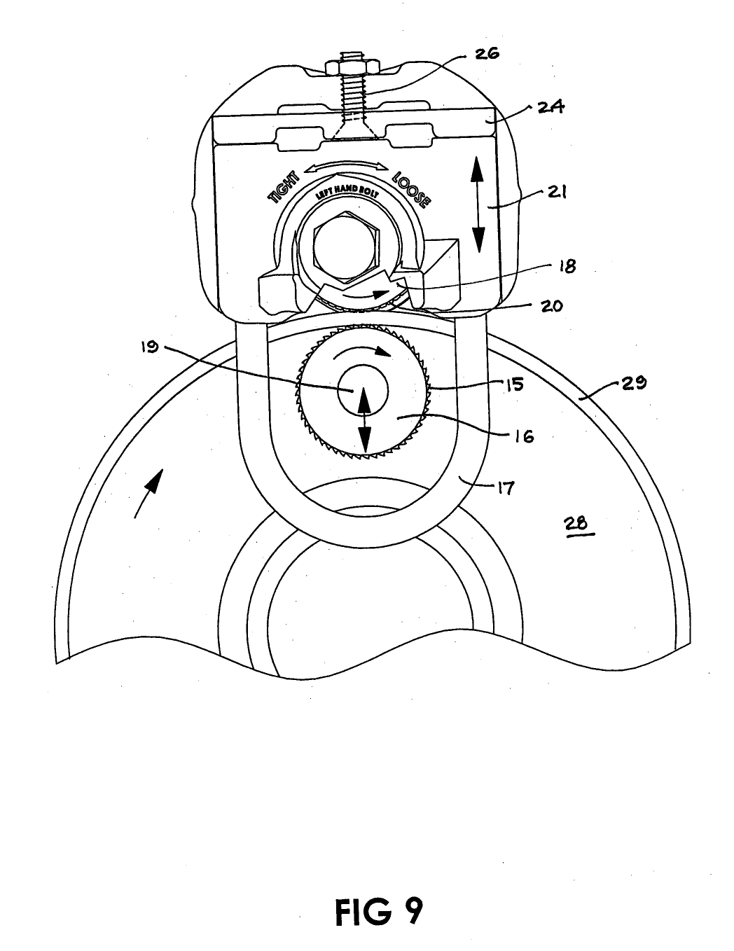

FIG. 9 illustrates an enlarged partial section view of the traction wheel, cutting wheel, can holder and cutting head housing. As seen in FIG. 9, the traction wheel 16, with ridge and groove edge 15, is engaged on the interior of the can seam 29, while the cutting wheel 18, with notched cutting edge 20, is engaged on the exterior of the can seam 29. The U-shaped can holder 17 is on top of the can 28 and extends from the cutting wheel housing 21 which at its rear side rests against rubber bumper 24. The bumper 24 is positionally adjusted by bolt 26. The bumper 24 enables the compression to be adjusted for smaller, thin seam cans as well as larger thick seam cans. The bolt 26 acts as a stopper for heavier large cans. The various arrows denote the respective directions of rotation and movement of the cutting wheel housing 21, the traction wheel 16, the cutting wheel 18 and the can 28.

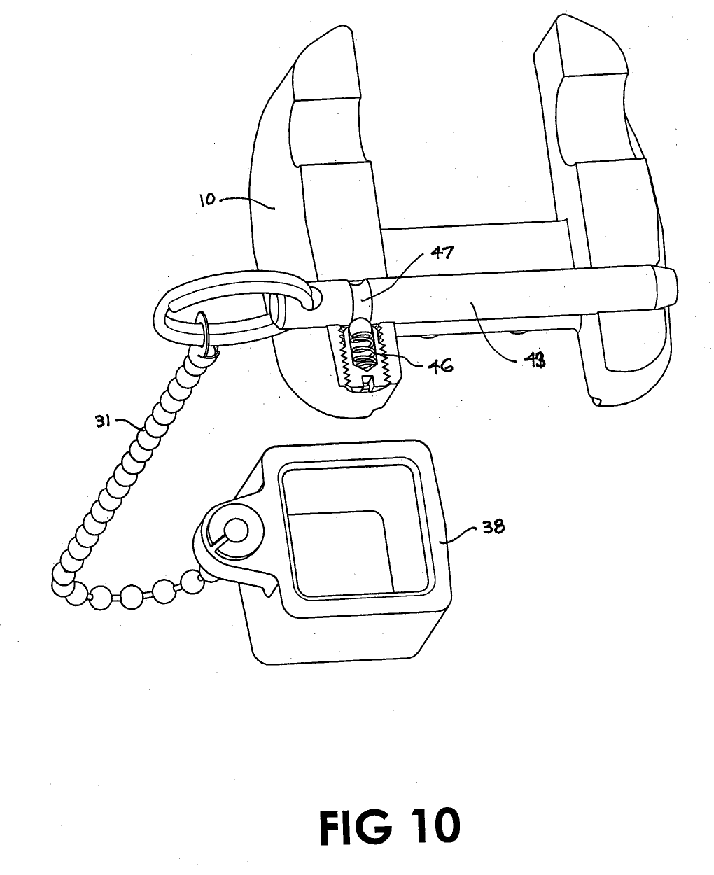

FIG. 10 illustrates an enlarged isometric partial section view of the bumper, housing and securing pin. In particular, FIG. 10 illustrates a detail of the rubber bumper 38, which is located at the base of the housing (not shown), the chain 31, and the engagement of locking pin 41 in housing 10 by a ball and spring 46 mechanism which fits in groove 47 of locking pin 41 to hold it in releasable position.

### Method of Operation of the Can Opener

The direct drive can opener according to the invention is easy to use, reliable, durable and easy to clean. As illustrated in FIGS. 1 to 10, the can opener 2 is clamped with clamp components 32, 34, 36 onto a bench 37 with the U-shaped can mount 33 extending on top of the bench 37. A can 28 is then placed on the U-shaped can mount 33 in a position such that the top seam 29 is in the gap 25 and against the cutting wheel 18 when the can opener 2 is in an open position, as shown in FIG. 1. The raise and lower lever 8 is then lowered, and the traction wheel 16 closes against the interior side of the seam 29, as illustrated in FIG. 2.

The can seam 29 is then ready for severing. By cranking rotary handle 6 in a horizontal clockwise direction, the operator causes traction wheel 16 and cutting wheel 18 to advance together around the top seam 29 of the can 28. This action causes cutting edge 20 to sever the exterior side of seam 29 of the can 28. Once the entire circumference of the seam 29 has been severed, the operator detaches the opener 2 from the can 28 by raising the lever 8, which widens the gap 25 and permits the can 28 and cut lid to be removed from the opener 2.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A can opener comprising:
(a) a rotatable cutting wheel which has thereon a serially notched cutting edge for severing a first side of a can seam of a can, said cutting wheel defining a cutting wheel axis;
(b) a rotatable traction wheel which has thereon a gripping surface for engaging a second side of the can seam opposite the cutting wheel, said traction wheel defining a traction wheel axis;
(c) a first member associated with said traction wheel for rotating said traction wheel; and
(d) a second member for engaging or disengaging said cutting wheel and said traction wheel on opposite sides of the can seam, the cutting wheel axis and the traction wheel axis being substantially parallel when the cutting wheel and the traction wheel are engaged on the can seam.

2. A can opener as claimed in claim 1 including a resilient bumper mechanism for enabling the distance between the cutting wheel and the traction wheel to be varied.

3. A can opener as claimed in claim 2 including an adjustable mechanism impinging on the resilient bumper mechanism for enabling the distance between the cutting wheel and the traction wheel to be varied to adjust to differences in widths of can seam.

4. A can opener as claimed in claim 1 wherein the cutting wheel includes thereon a serrated surface for gripping the seam of the can.

5. A can opener as claimed in claim 4 wherein the cutting wheel includes thereon a shoulder for aligning the can seam with the cutting wheel.

6. A can opener as claimed in claim 1 wherein the traction wheel includes thereon a series of alternating ridges and grooves for gripping the seam of the can.

7. A can opener as claimed in claim 6 wherein the ridges and grooves of the traction wheel are angled.

8. A can opener as claimed in claim 1 wherein the cutting wheel is contained in a first cutting wheel housing which can be removed from the interior of a second housing associated with the first member and the second member.

9. A can opener as claimed in claim 1 including a removable locking pin for securing the first cutting wheel housing in the second housing.

10. A can opener as claimed in claim 1 including an abutment member for impinging on the top of the can and guiding the movement of the can in the can opener during a seam cutting operation.

11. A can opener as claimed in claim 10 wherein the abutment member has a curved U-shape adapted to engage with a top of the can.

12. A can opener as claimed in claim 1 wherein the axis of said cutting wheel is disposed at an angle with respect to the plane of the top of a can.

13. A can opener as claimed in claim 8 wherein the first housing and the second housing are mounted on a post and the elevation of the can opener on the post can be adjusted.

14. A can opener as claimed in claim 13 including a resilient bumper at the base of the second housing.

15. A can opener as claimed in claim 13 wherein the post is slidably mounted in a clamp mechanism for mounting the can opener on a bench.

16. A can opener as claimed in claim 15 wherein the clamp mechanism includes a U-shaped can base holder.

17. A can opener as claimed in claim 8 wherein the first cutting wheel housing is designed so that it fits within the second housing in only one orientation.

18. A can opener as claimed in claim 5 wherein the serially notched cutting edge of the cutting wheel is located above the serrated surface which is located above the shoulder.
